(19) United States
(12) Patent Application Publication
(10) Pub. No.: US 2004/0181465 A1
(43) Pub. Date: Sep. 16, 2004

(54) Method for on-line outsourcing of customized merchandise containing personalized logo

(76) Inventor: Steven S. Kan, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/648,216

(22) Filed: Aug. 27, 2003

(30) Foreign Application Priority Data
Mar. 11, 2003 (TW) 92105269

(51) Int. Cl. G06F 17/60

(52) U.S. Cl. 705/27

(57) ABSTRACT

A method for on-line outsourcing of customized merchandise containing at least a personalized logo. An on-line remote customer personalizes preferred logo image and customizes preferred merchandise image by selecting image parts and part elements stored, respectively, in logo image and merchandise image databases. The server generates a customized merchandise image containing at least a personalized logo image after receiving the remote customer's indication of the location(s) and size(s) of the personalized logo image to be incorporated with the customized merchandise image. Outsourcing and customization order databases store, respectively, information of outsourcing invoice and customization order records. The server transmits the customized merchandise image containing at least a personalized logo and outsourcing invoice to a supplier to bind the production of the tangible, customized merchandise. The server also transmits the customized merchandise image containing at least a personalized logo and customization order to the remote customer to bind the customization.

### BACKGROUND OF THE INVENTION

1. Field of the Invention

The present invention pertains to a brand marketing method for on-line outsourcing of customized merchandise containing personalized logo. More specifically, it relates to a method for on-line assembly of image parts to generate a customized merchandise image containing at least a personalized logo image, and for the transmitting of the generated image as well as corresponding outsourcing information to a supplier for the production of the tangible, customized merchandise containing at least a logo.

2. Description of the Prior Art

A logo represents an image that an entity uses to impress on people and increase brand value. For example, the brand values of Coca Cola and Microsoft both are as high as tens of billion dollars. However, brand value can only be accumulated through continuous efforts of brand marketing and management. Enterprises such as Coca Cola, McDonald, Microsoft and Intel all possess high brand values as a result of continuous promotion of their joyful, convenient, reliable, or quality images.

Brand marketing method in the Internet era is growingly important. Some brand marketing methods originated from the Internet are quite impressive. For example, companies such as Yahoo and Amazon have gained a lot of attention and built up their communities by adopting relevant Internet technologies. For many more other traditional or Internet companies, new methods of brand marketing are in need to connect their potential customers. A new brand marketing method that uses Internet and digital image technologies to enable customers' personalization of a preferred logo, in particular, can help increase brand value.

Image is an important tool to communicate an idea. In many situations, images contain more abundant information than words do. In order to earn trust and identification from customers or the public, many companies convey their vision and products by meticulously designing various kinds of logos and icons. In fact, some company logos and product icons have become very important assets. Many customers would show their loyalty towards a brand by, for example, wearing a T-shirt or a hat containing a logo. Merchandises containing a logo image can not only be gifts or souvenirs, but also help promote brand value. Undoubtedly, the more people use or talk about a particular brand, the higher the brand value. With this background, personalized logo offers the additional value of personalization or personal expression on top of the standard logo. People will become more interested in knowing and comparing with personalized logos made by others. Personalized logo images will become a fun topic of social occasions and effectively increase brand value.

A piece of tangible, customized merchandise containing a personalized logo would further satisfy more of a customer's desire in expressing his/her personality. With the additional merchandise customization, one can go beyond personalized logo and obtain some individualistic value for oneself. However a customized T-shirt containing a personalized logo is desirable, for example, it cannot be obtained at low cost in the present time. Using Internet and image technologies, the present invention disclose a low-cost method to satisfy customer desire and increase brand value.

Prior arts of digital imaging technology have matured greatly in the past 10 years and enabled a variety of software off-line or on-line. Digital image can be easily duplicated, overlapped, decomposed or recomposed. It is advantageous over traditional image carriers in that no irreparable damage due to repetitive operations would occur. Examples of powerful and popular off-line image-processing or editing software include PhotoShop®, Illustrator®, CorelDRAW®, PhotoImpact and PageMaker etc. Along with the advance of Internet technology, digital image finds more and more use on-line for apparent reasons. The U.S. Pat. No. 5,710,897 discloses that a user can set the shapes and sizes of an icon as a mouse pointer. In the field of fashion, an invention of U.S. Pat. No. 5,930,769 allows remote customer to select and purchase fashion clothes that are displayed as digital images on web pages. The U.S. Pat. No. 5,880,740 discloses a computer system manipulating graphical composite image composed of elements selected by user from sequentially displayed members of stored image sets. The U.S. Pat. No. 6,041,335 further provided an image postscript method that allows one digital image to superimpose onto another. In business practice, many Internet sites are now providing service of personal album editing and sharing, for example www.photoisland.com. The website, www.designitgear.com, further provides remote soccer fans with logo images and color compositions as options for visitors to personalize preferred logo image in preferred color.

Taiwan patent No. 498240 also discloses a method for on-line assembly of personalized image. The method provides a plurality of constituent image parts of a default image for remote users to select on-line. Each constituent image part further has a plurality of part elements grouped into several categories according to their characteristics. The server assembles the image parts according to corresponding part elements selected by a remote customer to generate the personalized image. Utilizing the method, a remote customer is able to personalize a logo image or customize a merchandise image on-line. However, the method cannot help a remote customer to obtain a piece of tangible, customized merchandise containing at least a logo. The primary reason is that a business promoting brand value simply does not have the ability to produce the tangible, customized merchandise. For example, McDonald is in restaurant business but not in toys business just as Elizabeth Arden is in the perfume business but not in the coffee mug business. There is therefore a need to improve from current practices so that an entity can outsource to a third-party supplier for the production of tangible, customized merchandise containing at least a logo.

### SUMMARY OF THE INVENTION

The thrust of the present invention is to improve upon prior arts in brand marketing so that non-profit or for-profit entities can effectively use Internet as well as digital imaging technologies to win popular recognition and brand loyalty at a lower cost.

An object of the present invention is to provide an entity the opportunity to increase customers' identification with it through on-line participation of logo image personalization. The fun personalization experience and resulting personalized logos can become topics of social occasions and therefore increase brand value beyond that of a standard logo image.

Another object of the present invention is to provide an entity the opportunity to additionally increase the customers' expression of his/her individuality through on-line customization of tangible merchandise containing at least a personalized logo. Different personalized logos appearing on tangible merchandises help not only show interesting diversity but also build a pluralistic, loyal community of the brand. The ability to customize merchandise design further lends customers the opportunity to freely embed their personalities in the customized merchandise. Brand value further increases when people look around for others' designs, talk about them, and are stimulated to compete for better designs.

Another object of the present invention is therefore to provide the opportunity for remote customers to upload their own image designs.

A further object of the present invention is to enable an entity to outsource the production of the tangible, customized merchandise containing at least a personalized logo. A brand promoting entity typically is not in the line of producing the kind of merchandise suitable to carry a personalized logo. Outsourcing is particularly costly through verbal description or printed pictures because logo personalization and merchandise customization involve complicated design specifications. An improved method adopting digital imaging and Internet technologies can help significantly lower the costs associated with the transmission of complicated design and order information to the supplier.

A still further object of the present invention is therefore to enable an outsource supplier's better monitoring of workflow and a customer's easier examination of the delivered product. Personalization or customization implies that the production of tangible merchandise must be modified to enable better monitoring of workflow so that complicated design specifications can be exactly followed. Similarly, there is a need to enable easier examination of the delivered products by customers. Otherwise, suppliers' shoddy products will only cause customer dissatisfaction and work against the goal of brand promotion.

The objects of the present invention are attained with the following features. Customers' on-line logo personalization or merchandise customization, for instance, can be done by invoking the method of on-line assembly of personalized images, as disclosed in Taiwan patent No. 498240 which involves essentially:

(A) providing an image database comprising a plurality of constituent image parts of a default image, and providing a plurality of part elements showing characteristics of the constituent image parts;

(B) providing a customer database containing remote customers' identity, account, and login data;

(C) accepting a remote user's request to log in and use the image database in a network environment;

(D) accepting the remote user's selection of image parts and part elements to assemble a personalized image;

(E) generating a unique identification code corresponding to the assembled personalized image, wherein the unique identification code comprises the unique codes of every part elements selected by the remote user.

The present invention therefore involves the provision of logo image and merchandise image databases that store, respectively, the constituent image parts of at least a default logo or merchandise image, and their corresponding part elements for logo image personalization or merchandise image customization.

To attain the object of generating a customized merchandise image containing at least a personalized logo image, the method of the present invention further involves the remote customer's indication of the position(s) and size(s) of the personalized logo image to be incorporated with the customized merchandise image. The object of providing an opportunity for a remote customer to upload a self-designed image part is attained by allowing the server to receive and examine the uploaded image part before accepting and storing it to respective image database, thereby enriching selective options for other remote customers as well.

After the customized merchandise image containing at least a personalized logo image is generated, the outsourcing object is attained, in part, with the provision of outsourcing and customization order databases. The outsourcing database contains at least business information of a supplier and data of outsourcing invoice records. The customization order database contains at least data of customization order records.

The outsourcing object is accomplished, further, by transmitting the customized merchandise image containing at least a logo image and an outsourcing invoice to the supplier to bind the production of the tangible, customized merchandise according to the image design specifications. The object to enable an outsource supplier's better monitoring of workflow and a customer's easier examination of the delivered product is essentially accomplished by respectively transmitting to them the corresponding unique identification codes of the personalized logo image as well as the customized merchandise image, and the position and size information to incorporate the personalize logo image with the customized merchandise image. A personalized logo image or a customized merchandise image has its unique identification code consisting of the unique codes of every part elements selected by a remote customer. The customized merchandise image containing at least a personalized image also has its unique identification code set consisting of the unique identification codes of the customized merchandise image and the personalized logo image. The supplier and the remote customer therefore can, respectively, use the unique identification codes to help monitor the production workflow and examine the delivered product.

### BRIEF DESCRIPTION OF THE DRAWINGS

FIG. 1: is a block diagram illustrating a system for on-line assembly of personalized logo image of the first embodiment.

FIG. 2: is a flowchart illustrating the steps involved in personalizing a logo image of the first embodiment.

FIG. 3: illustrates an example of image parts and part elements in personalizing a preferred logo of the present invention.

FIG. 4: shows a system block diagram for the present invention's method for on-line outsourcing of customized merchandising containing personalized logo.

FIG. 5: shows a flowchart indicating the steps for outsourcing customized merchandise containing personalized logo of the second embodiment.

### DETAILED DESCRIPTION OF THE PREFERRED EMBODIMENTS

By a logo of the present invention, it means a business or non-profit entity's logo, trademark, service mark, or icon representing a product, a work, a character, or an activity. A logo image in the present invention refers to digitized 2-D or 3-D image consisting of alphabets, numbers, symbols, or pictures. For the purpose of illustration, a hypothetical logo of ‘charge’, consisting of alphabets only, is used below to describe the method of the present invention.

For illustration purpose, the present invention discloses two embodiments that are denoted as the first embodiment and the second embodiment. The first embodiment entails a method for on-line assembly of a personalized logo image or a customized merchandise image. The second embodiment shows a method for on-line outsourcing of the production of tangible, customized merchandise containing at least a personalized logo. The descriptions of the two embodiments are elaborated in details in the followings.

The first embodiment: On-line Assembly of Personalized Logo Image

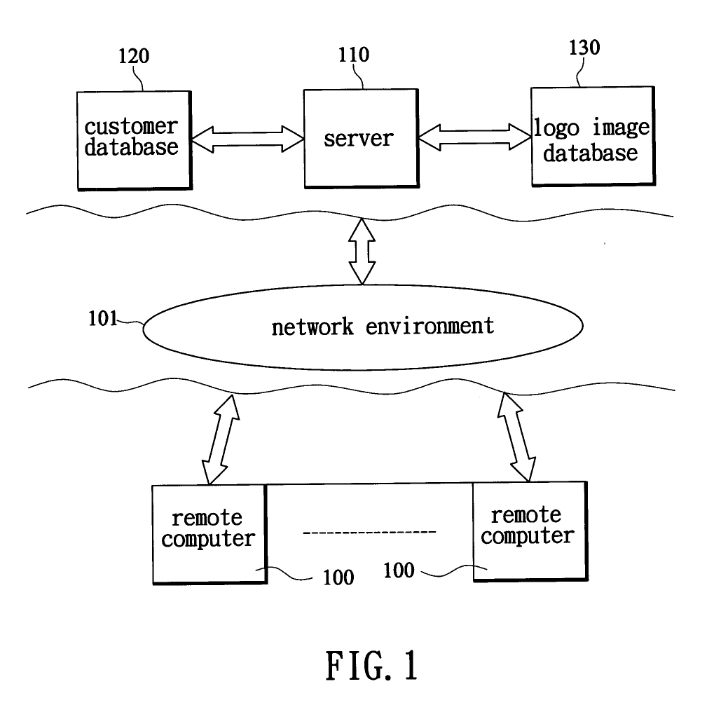

FIG. 1 illustrates a system for on-line assembly of personalized logo image of the present invention. A remote computer 100 connects to a server 110 in a network environment 101, which entails at least a network such as Internet, Local Area Network, Proprietary Network, or a wireless communication network. Hereinafter, the “remote computer” is interchangeable with the “remote user” to represent a remote terminal accessing the server. The remote computer 100 consists of at least a display means, a storage means, an I/O means, and a communication means that can connect to the network environment 101. The remote computer 100 can therefore connect with the server 110 through a dial-up service using modem as a communication means, for example. A mobile phone that is equipped with graphical functions or PDA that is equipped with communication functions can also connect the remote customer 100 with the server 110 through a wireless communication network.

The server 110 includes at least a processing means, a storage means, and an I/O means that can connect it with network environment 101. The processing means consists of a CPU, memory unit such as DRAM, RAM, and ROM, and related operation system software. The storage means includes various electronic data carriers such as a hard disk, floppy disk, and CD etc. The I/O means includes a graphic card. A customer database 120 and a logo image database 130 are needed in practicing the present invention and stored in the storage means. The customer database 120 stores relevant user information obtained from a plurality of remote customers 100. The user information includes customers' personal information that can help the server 110 to authenticate a customer and authorize access to logo personalization. The logo image database 130 stores a plurality of constituent image parts of a default logo image, and a plurality of part elements showing characteristics of the constituent image parts. The part elements may further be grouped into a plurality of categories reflecting their distinct attributes such as shape, style, pattern, special effect, contour, color, size, material, and production technique. The material and production technique categories are desirable because they are important characteristics for the production of a tangible, personalized logo.

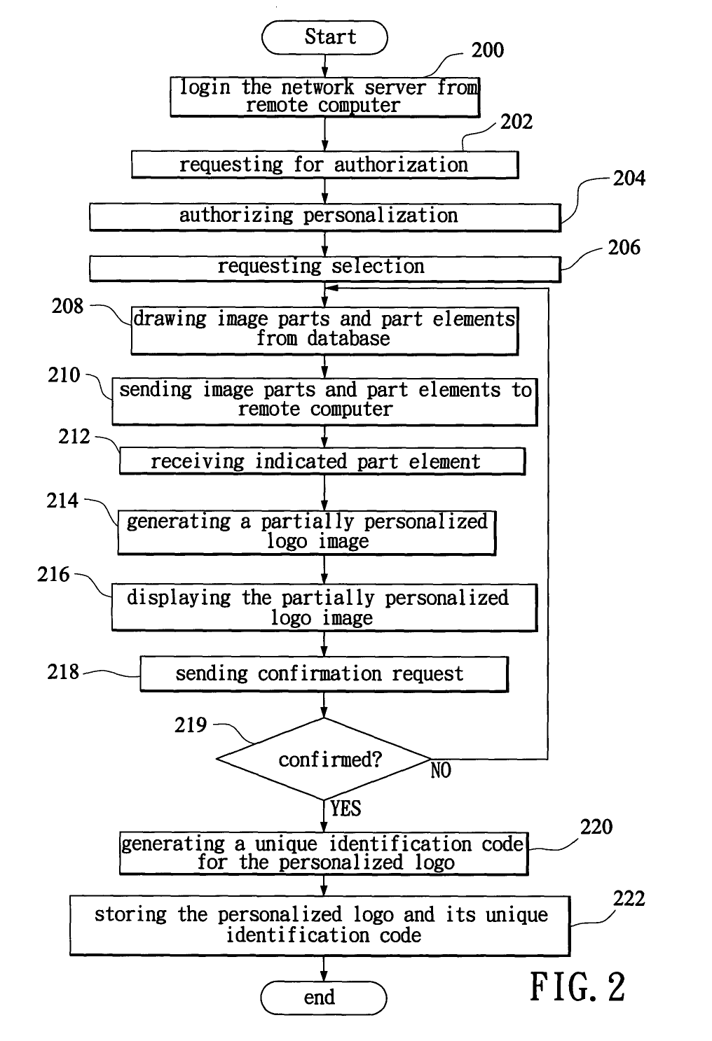

FIG. 2 is a flowchart showing the steps for personalizing a logo image of the present invention. A remote customer logs in the server (step 200) and requests for an authorization (step 202) to begin a personalization session. After authentication, the server authorizes the personalization by transmitting at least a constituent image part and a part element (step 204) to the remote computer's display device. The remote customer then sends requests to the server to select and set preferred image parts and part elements (step 206). The server then draws from the logo image database for constituent image parts and part elements for the personalization (step 208). One at a time or in batches, the server sends part elements (step 210) that are categorized according to their distinct attributes for the remote customer to select and set the preferred part.

Next, the server receives the remote customer's indication of a selected part element (step 212). The server then generates a partially personalized logo image by replacing the selected image part and part element for the default ones (step 214). The server also transmits the generated personalized logo image to the remote computer for the remote customer to examine and confirm his/her selection and setting of the preferred design (step 216). The remote customer can repeat steps 208 to 216 to select further until all constituent image parts are replaced with selected part elements to obtain a completely personalized logo. When the remote customer does not personalize all constituent image parts, the generated personalized logo will contain the selected and the remaining default part elements. In any event, the server sends a confirmation message to the remote customer to ask if a logo personalization is done (step 218) and examines whether confirmation from the remote customer is received (step 219). After receiving the confirmation, the server then generates a unique identification code that one-to-one corresponds to the personalized logo (step 220). The unique identification code for the personalized logo consists of the unique codes of each part element selected and the unique codes of default part elements that are not replaced in the personalization session. Finally, the server stores the personalized logo and its unique identification code (step 222).

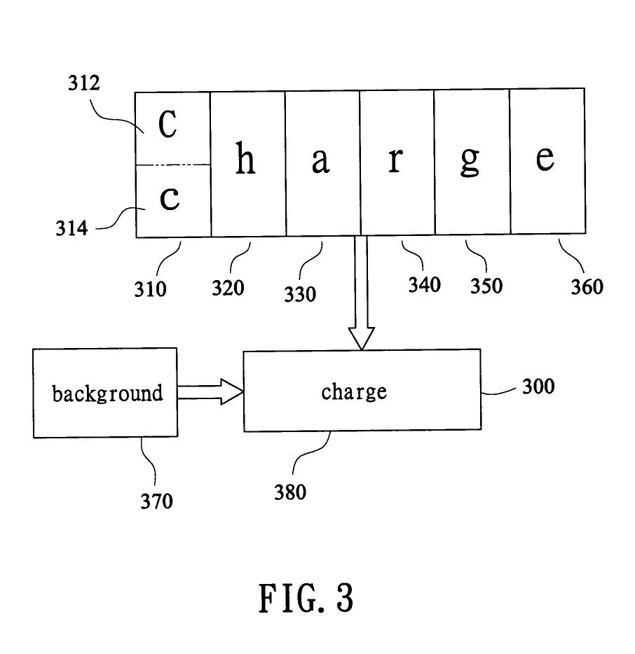

FIG. 3 presents ‘charge’ as a logo and illustrates the constituent images parts and part elements involved in the present invention. The diagram includes a complete logo image, its constituent image parts, and the selectable part elements. More specifically, ‘charge’ 300 is a default logo image of 6 different alphabets. The boxes shown in the diagram indicates that there are 6 constituent image parts, each character constituting an image part. The constituent image parts are numbered from left to right as 310, 320, 330, 340, 350, and 360. An additional image part 370 is also shown to represent the background in which the logo image sits. As shown in FIG. 3, the box 310 is further divided into two smaller boxes separated by a phantom line. It means to indicate that there are two selectable part elements corresponding to the image part 310. The two part elements, 312 and 314, apparently have different shapes. The resulting personalized logo 380 after a personalization session is also shown in the figure.

FIG. 3 shows only two part elements for image part 310 for simplicity. Without loss of generality, there can be more part elements. There can also be many more part elements for other image parts, including the background. If each image part has two part elements for a remote customer to choose from, then there will be 128 varieties of personalized logos. The same principle shows that with 10 part elements for each image part there will be 10 million different personalized logos.

The present invention further groups part elements into different categories according to their distinct attributes. For example, part elements can be grouped into three categories such as shape, pattern, and color. Suppose a logo has 4 constituent image parts. Suppose further that there are 5 part elements in the shape category, 6 part elements in the pattern category, and 7 part elements in the color categories. It can be easily seen that the number of different personalized logo is more than 1.6 billions. Adding more categories not only help to guide remote customers' personalization design but also enhance greater diversity in the resulting personalized logos.

The present invention also allows remote customer 100 to upload his/her edited or self-designed logo image, image parts, or part elements. After being accepted, the uploaded image, image parts, or part elements will be stored in the logo image database 130. Remote customers 100 can use mobile phone or PDA devices to upload the related images to the server 110 via wireless communications network 101. They can also just draw their designs by hand and send through regular mail for the administrators to convert it into digital file and store in the logo image database 130. An acceptance procedure is, nevertheless, needed before storing the self-edited or self-designed images uploaded by remote customers. The necessary check by the database administrator to insure against viruses, protect copyrights, and weed out obscenity is obviously very important for a brand promoting entity. Another reason for the necessary acceptance procedure is to ascertain that a supplier can produce a piece or a part of tangible merchandise according to the uploaded design.

The second preferred embodiment: On-line Outsourcing of Customized Merchandise Containing Personalized Logo Image.

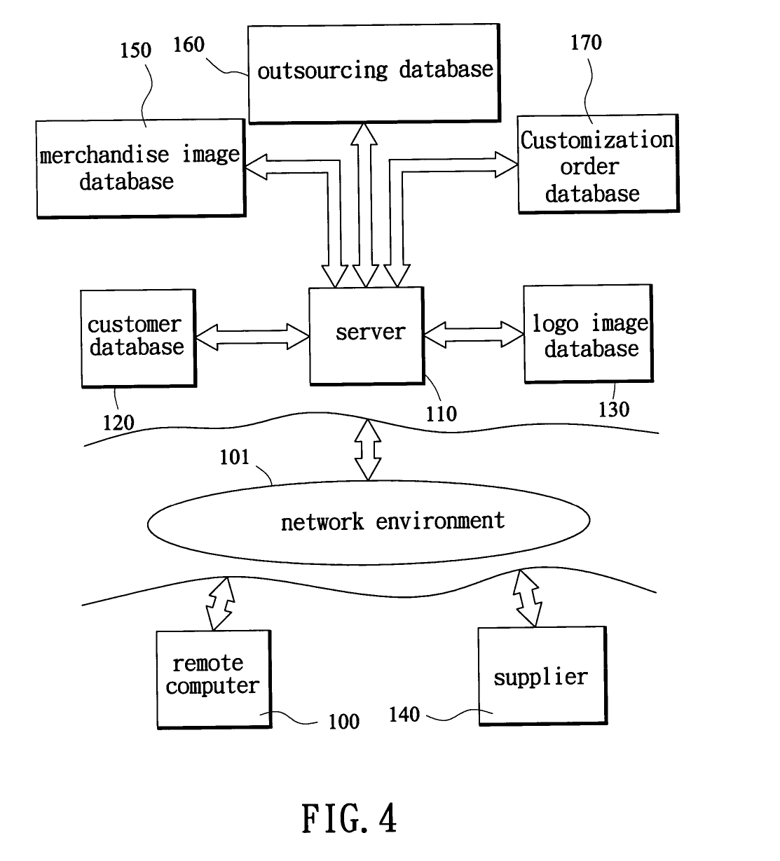

FIG. 4 illustrates a system block diagram for on-line outsourcing of customized merchandise containing personalized logo image. To enable a remote customer 100 for customizing a T-shirt, mug, or a piece of any other tangible merchandise containing at least a personalized logo, a business or non-profit entity must allow its server 110 to authorize on-line assembly of customized merchandise and personalized logo images in a network environment 101. An entity promoting its brand does not usually have the ability to produce a piece of customized merchandise and needs to outsource the job to a supplier 140. The second embodiment of the present invention, therefore, needs a customer database 120, a logo image database 130, and a merchandise image database 150, as shown in FIG. 4.

Due to the rich informational content, the outsourcing and final delivery of customized merchandise involve a complicated process and are prone to result in error, if not managed properly. The present invention, thus, provides an outsourcing invoice so that the design information of the customized merchandise image containing at least a personalized logo image can be correctly transmitted from the server 110 to the supplier 140 and helps its internal departments' production operations. The present invention also provides a customization order to bind a remote customer and help his/her examination on delivery of the tangible, customized merchandise containing at least a logo. To achieve the purpose, the customization order contains as well the design information of the customized merchandise image containing at least a personalized logo image. The second embodiment of the present invention, thus, also provides an outsourcing database 160 and a customization order database 170 to store relevant information.

The second embodiment therefore involves essentially the incorporation of the customized merchandise image and the personalized logo image into one digital image, the generation of a unique identification code set for the new image, and the transmitting of the outsourcing invoice and customization order that contain relevant pieces of information. The following detailed description starts with the assumption that remote customer 100 has already completed logo personalization as disclosed in the first embodiment.

Similar to the logo image database of the first embodiment, the server end's merchandise image database 150 stores a plurality of constituent image parts of a default merchandise image, and a plurality of part elements showing characteristics of the constituent image parts. The part elements are further grouped into a plurality of categories reflecting their distinct attributes such as shape, style, pattern, special effect, contour, color, material, size, and production technique. The server also permits remote customer 100 to upload edited or self-designed merchandise image, image parts, or part elements. An acceptance procedure to approve self-designed or edited images is also necessary to insure against viruses, protect copyrights, and weed out obscenity. Another reason for the necessary acceptance procedure is to ascertain that a supplier can produce a piece or a part of the tangible merchandise according to the uploaded design. The approved, uploaded images will then be store in the merchandise image database 150 to enrich image designs for all remote customers' selection.

Production techniques for various customized merchandises are usually different because remote customers would prefer certain materials for certain design and some production techniques suit better for certain materials. In addition, the present invention allows customization of parts for merchandise and different parts can be produced by different methods. As a piece of tangible, customized merchandise of the present invention contains at least a logo, the production of logo that consisting of a plurality of parts can also use different production techniques for different parts. Thus, the present invention provides categories of materials and production techniques for remote customers to indicate how their logo and merchandise parts should be made. The production techniques of the present invention include digital printing, thermal transfer printing, embroidery, kilning, injection molding, mold pressing, stitching, pasting, engraving, etching, carving, forging, soldering, electro-plating, painting, sculpturing, brushing, and spraying, etc.

Additionally, similar to what is disclosed in the first embodiment for the personalized logo, a merchandise image of the second embodiment can be presented in either 2-D or 3-D manner. And each part element of a merchandise image has a corresponding unique identification code. As a result, the server 110 generates a unique identification code, consisting of the codes of each part element, for a customized merchandise image.

The outsourcing database 160 stores business information of at least a supplier 140. The business information of a supplier includes at least its business registration data, and may also include the production techniques the supplier is capable of doing. The outsourcing database 160 stores also data of outsourcing invoice records. An outsourcing invoice includes data such as the identity of the outsourcing party, the identity of the supplier 140, the outsourcing case number, the unit price and the quantity ordered, and the unique code of the customized merchandise image containing at least a logo image, etc.

The customization order database 170 stores data of customization order records. A customization order includes data such as the identity of the remote customer 100, the identity of the supplier 140, the outsourcing case number, the customization order number, the unit price and the quantity ordered, and the unique code of the customized merchandise image containing at least a logo image, etc.

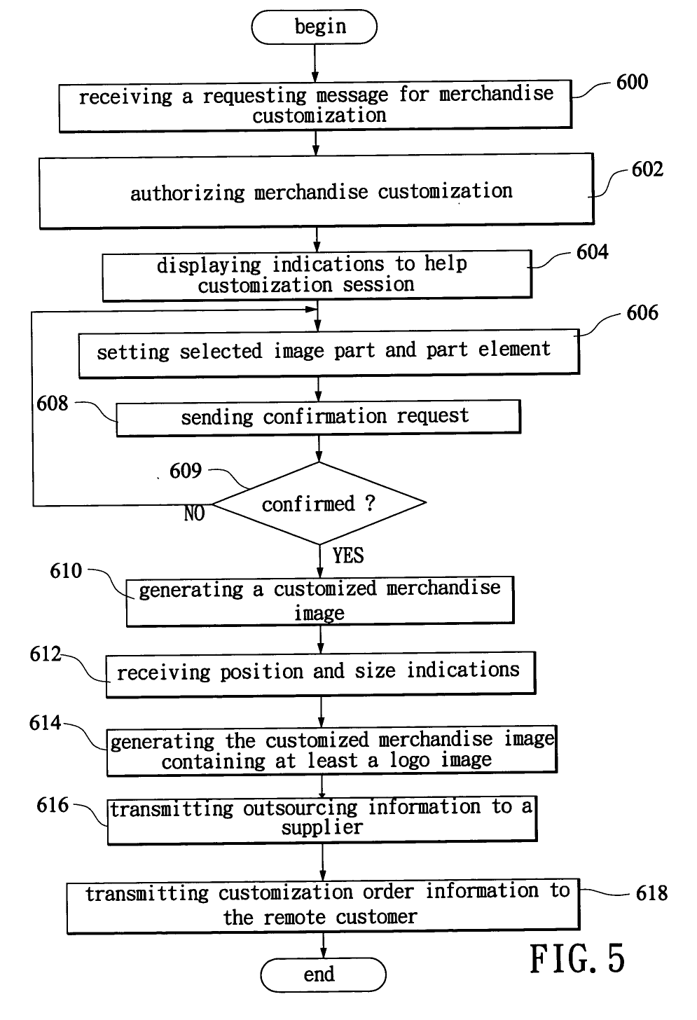

FIG. 5 shows a flowchart indicating the steps for outsourcing of the customized merchandise containing personalized logo in the second embodiment. Again, the login, the authorization, and the logo image personalization are assumed to have been completed and we start with the customization of a merchandise image to avoid unnecessary repetition.

The server receives a request message for merchandise customization from a remote customer (step 600). The server authorizes the customization by transmitting at least a constituent image part and at least a part element to the remote customer (step 602). The server also displays at remote computer end indications for the remote customer to proceed with the customization session (step 604). The remote customer then requests the server's setting of the selected, preferred image part and the part elements (step 606). The detailed steps, though not shown here, are similar to that disclosed in the logo personalization session and a remote customer can repeat the steps until all constituent image parts are replaced with selected part elements to obtain a completely personalized logo. When the remote customer does not personalize all constituent image parts, the generated personalized logo will contain selected and remaining default part elements. In any event, the server sends a confirmation message to the remote customer (step 608) and examines whether confirmation from the remote customer is received (step 609). After confirmation, the server then generates a customized merchandise image according to the remote customer's selections of image parts and part elements and displays it on the remote customer's computer (step 610). After receiving confirmation of the generated merchandise image, the server then request and receives from the remote customer the preferred position(s) and size(s) of the personalized logo image to be incorporated with the merchandise image (step 612). The server then generates the customized merchandise image containing at least a personalized logo image (step 614).

After the remote customer's confirmation of outsourcing the production of tangible, customized merchandise according to the customized merchandise image containing at least a personalized logo image, the server transmits the customized merchandise image containing at least a personalized logo image, its unique identification code, the information of location(s) and size(s) for the personalized logo image to be incorporated with the customized merchandise image, and an outsourcing invoice to a supplier (step 616). The server also transmits the customized merchandise image containing at least a personalized logo image, its unique identification code, the information of location(s) and size(s) for the personalized logo image to be incorporated with the customized merchandise image, and a customization order to the remote customer (step 618). The information transmitted to the supplier and the remote can help not only the supplier's ease of management of production workflows for a better product, but also the customer's examination of the tangible, customized merchandise on delivery. Thereby, the present invention can help significantly enhance e-commerce and lead to win-win-win situation for the brand promoters, the suppliers, and customers.

Through the description of the above two embodiments, anyone with ordinary skill in the field of electronic commerce can practice the present invention after becoming familiar with the above-mentioned steps. The present invention thus provides a competitive edge for adopting businesses or non-profit entities in promoting their brand values and winning customers' loyalty. Employing the disclosed method, they can not only carry out brand-marketing at low cost, but also satisfy customers' desire to express their individuality with joyful community spirits.

Although the present invention has been described with reference to the two specific embodiments, it is to be understood that they are merely illustrative and the invention is not limited to the disclosed embodiments. On the contrary, the present invention is intended to cover various changes, alterations, rearrangements, modifications, and equivalent structures included within the spirit and scope of the appended claims.

What is claimed is:

1. A method for on-line outsourcing of customized merchandise containing personalized logo, wherein a remote customer in a network environment is connected to a server to customize a piece of tangible merchandise containing at least a personalized logo and the server outsource its production to a supplier; the method comprises steps of:
(a) providing a logo image database at the server end, wherein the database stores a plurality of constituent image parts of at least a default logo image and a plurality of part elements showing characteristics of the constituent image parts;
(b) providing a merchandise image database at the server end, wherein the database stores a plurality of constituent image parts of at least a default merchandise image and a plurality of part elements showing characteristics of the constituent image parts;
(c) personalizing a preferred logo image, by the remote customer, by selecting at least an image part and at least a part element stored in the server's logo image database for the server's on-line generation of the remote customer's personalized logo image;
(d) customizing a preferred merchandise image, the remote customer, by selecting at least an image part and at least a part element stored in the server's merchandise image database for the server's on-line generation of the remote customer's customized merchandise image;
(e) generating, by the server, the customized merchandise image containing at least a personalized logo image by incorporating the personalized logo image with the customized merchandise image selected by the remote customer; and
(f) transmitting, by the server, the generated customized merchandise image containing at least a personalized logo image to a supplier for the production of at least a piece of tangible, customized merchandise according to the said customized merchandise image containing at least a personalized logo image.

2. The method according to claim 1, wherein the network environment involves at least one of the Internet, a local area network, a proprietary network and a wireless communication network.

3. The method according to claim 1, wherein said logo image in step (a) consists of at least one of digitized alphabet, number, symbol, and picture presented in 2-D or 3-D manner

4. The method according to claim 1, wherein said logo means a business or non-profit entity's identity logo, trademark, service mark, or icon representing a product, a work, a service, a character, or an activity.

5. The method according to claim 1, wherein each said part element of a logo image of step (a) has a unique code.

6. The method according to claim 1, wherein said part elements of step (a) are further grouped into a plurality of categories reflecting distinct attributes including at least one of shape, style, pattern, special effect, contour, color, material, size, and production technique.

7. The method according to claim 1, wherein said merchandise image of step (b) is a digitized, 2-D or 3-D, image representing a piece of tangible merchandise.

8. The method according to claim 1, wherein said part elements of merchandise image of step (b) are further grouped into a plurality of categories reflecting distinct attributes including at least one of shape, style, pattern, special effect, contour, color, material, size, and production technique.

9. The methods according to claims 6 and 8, wherein said production technique category includes at least one of digital printing, thermal transfer printing, embroidery, kilning, injection molding, mold pressing, stitching, pasting, engraving, etching, carving, forging, soldering, electro-plating, painting, sculpturing, brushing, and spraying.

10. The method according to claim 1, wherein each said part element of the merchandise image of step (b) has a unique code.

11. The method according to claim 1, wherein step (c) is further preceded by a step of authorizing the remote customer's request for on-line logo personalization.

12. The method according to claim 1, wherein said personalized logo image of step (c) has a unique identification code consisting of each logo part element's unique code.

13. The method according to claim 1, wherein step (c) is further followed by the step of displaying, at the remote customer end, the personalized logo image generated by the server according to said remote customer's selection of at least an image part as well as at least a part element to assist said remote customer's confirmation of the logo personalization.

14. The method according to claim 1, wherein step (d) is further preceded by the step of authorizing the remote customer's request for on-line merchandise customization.

15. The method according to claim 1, wherein said customized merchandise image of step (d) has a unique identification code consisting of each part element's unique code.

16. The method according to claim 1, wherein step (d) is further followed by the step of displaying, at the remote customer end, the customized merchandise image generated by the server according to said remote customer's selection of at least an image part and at least a part element to assist said remote customer's confirmation of the merchandise customization.

17. The method according to claim 1, wherein step (d) further comprises the steps of:
receiving, by the server, the remote customer's upload of an edited or self-designed part element for a logo image or a merchandise image;
storing, by the server after approval, said edited or self-designed part element in the corresponding logo image or merchandise image database.

18. The method according to claim 1, wherein step (e) is further preceded by the step of receiving the remote customer's indication of preferred location(s) and size(s) of said personalized logo image to be incorporated with the customized merchandise image.

19. The method according to claim 1, wherein step (e) is further followed by the steps of displaying, at the remote customer end, said customized merchandise image containing at least a personalized logo to assist said remote customer's confirmation of the preferred location(s) and size(s).

20. The method according to claim 1, wherein said customized merchandise image containing at least a personalized logo image of step (e) has a unique identification code set consisting of the unique identification codes of the constituent customized merchandise and personalized logo images.

21. The method according to claim 1, the method further comprising the steps of:
providing an outsourcing database at the server end, wherein the database stores business information of at least a supplier and data of outsourcing invoice records; and
providing a customization order database at the server end, wherein the database stores data of customization order records.

22. The method according to claim 1, wherein step (f) is further preceded by the step of receiving confirmation, from the remote customer, for the outsourcing of the production of said tangible, customized merchandise according to the said customized merchandise image containing at least a personalized logo image.

23. The method according to claim 1, wherein step (f) further comprises the steps of:
transmitting information of the preferred location(s) and size(s) of the logo image to be incorporated with the customized merchandise image to said supplier;
transmitting an outsourcing invoice to a remote supplier to bind the supplier's production of said tangible, customized merchandise containing at least a logo; and
transmitting to the remote customer a customization order, information of the preferred location(s) and size(s) of the logo image to be incorporated with the customized merchandise image, and said customized merchandise image containing at least a personalized logo image to bind the merchandise customization.

24. The method according to claim 21, wherein said supplier's business information at least include its business registration data, and wherein said outsourcing invoice record includes an outsourcing case number, the unique identification code set of the customized merchandise image containing at least a personalized logo image, and information of the unit price, the ordered quantity, the total amount, the name and address for delivery, and the deadline of delivery.

25. The method according to claim 21, wherein said customization order record comprises a customization order number, the outsourcing case number, the unique identification code set of the customized merchandise image containing at least a personalized logo image, and information of the unit price, the ordered quantity, the total amount, the name and address for delivery, and the deadline of delivery.

26. The method according to claim 24, wherein said outsourcing invoice record further comprises a customization order number.
